(19) United States
(12) Patent Application Publication
(10) Pub. No.: US 2026/0082357 A1
(43) Pub. Date: Mar. 19, 2026

(54) Indoor Location System

(71) Applicant: Radar Labs, Inc., New York, NY (US)

(72) Inventors: Nicholas Patrick, Jersey City, NJ (US); Timothy Julien, Brooklyn, NY (US); Gregory Sadetsky, New York, NY (US); Liam Edward Meier, Brooklyn, NY (US)

(21) Appl. No.: 19/331,207

(22) Filed: Sep. 17, 2025

Related U.S. Application Data
(60) Provisional application No. 63/696,023, filed on Sep. 18, 2024.

(51) Int. Cl. H04W 64/00; H04B 1/7163; H04W 4/021; H04W 4/33

(52) U.S. Cl. CPC H04W 64/00; H04B 1/7163; H04W 4/021; H04W 4/33

(57) ABSTRACT

An indoor positioning system includes mobile devices and ultrawideband beacons that communicate over out-of-band channels. The mobile devices may retrieve beacon data from advertising channels or servers using Bluetooth Low Energy or REST APIs. The mobile devices generate and advertise device data for ultrawideband two-way ranging sessions. The beacons and mobile devices perform ultrawideband ranging to obtain distance measurements. The mobile devices calculate their positions using the distance measurements. The system may transition between GPS and ultrawideband positioning based on geofencing or accuracy comparisons. Load balancing may manage ranging sessions between multiple beacons and devices. The out-of-band communication enables efficient configuration exchange and seamless indoor/outdoor positioning.

### CROSS-REFERENCE TO RELATED APPLICATIONS

This application claims priority to U.S. patent application Ser. No. 63/696,023, filed Sep. 18, 2024, and titled “Indoor Location System,” the disclosure of which application is incorporated by reference herein in its entirety.

### TECHNICAL FIELD

The present disclosure generally relates to smart devices, and in particular to systems and methods for locating smart devices indoors using beacons.

### BACKGROUND

Smartphones have become ubiquitous in modern society, offering users a wide range of functionalities including the ability to determine their location. While outdoor positioning using GPS technology is well-established, accurate indoor positioning remains a challenge due to the limitations of GPS signals in enclosed spaces. This has led to increased interest in developing reliable indoor positioning systems that can provide precise location information within buildings, underground structures, and other areas where GPS signals are weak or unavailable. As the demand for location-based services in indoor environments continues to grow, there is a need for improved systems that can provide highly accurate positioning information while addressing challenges such as scalability, power efficiency, and integration with existing smartphone capabilities.

There is a need in the art for a system and method that addresses the shortcomings discussed above.

### SUMMARY

In some aspects, the techniques described herein relate to a mobile device, including: an ultrawideband component for sending and receiving ultrawideband signals; a networking component; the mobile device configured to: retrieve, using the networking component, beacon data from one or more advertising communication channels, the beacon data associated to an ultrawideband beacon; generate mobile device data for the ultrawideband beacon, the mobile device data corresponding to an ultrawideband two-way ranging session; advertise, using the networking component, the mobile device data over the one or more advertising communication channels; use the ultrawideband component to perform two-way ranging with the ultrawideband beacon and obtain a distance measurement; and calculate a position for the mobile device using the distance measurement.

In some aspects, the techniques described herein relate to a mobile device, including: an ultrawideband component for sending and receiving ultrawideband signals; a networking component; the mobile device configured to: retrieve, using the networking component, beacon data from a server, the beacon data associated to an ultrawideband beacon; generate mobile device data for the ultrawideband beacon, the mobile device data corresponding to an ultrawideband two-way ranging session; send the mobile device data, using the networking component, to the server; use the ultrawideband component to perform two-way ranging with the ultrawideband beacon and obtain a distance measurement; and calculate a position for the mobile device using the distance measurement.

In some aspects, the techniques described herein relate to an ultrawideband beacon, including: an ultrawideband component for sending and receiving ultrawideband signals; a networking component; the beacon configured to: create beacon data including information for mobile devices trying to engage in ultrawideband ranging with the beacon; advertise, using the networking component, the beacon data over an advertising communication channel; retrieve, using the networking component, mobile device data generated by a mobile device over the advertising communication channel, the mobile device data corresponding to an ultrawideband two-way ranging session; and use the ultrawideband component to perform two-way ranging with the mobile device and obtain a distance measurement.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 illustrates a network diagram for an indoor positioning system, according to an embodiment;

FIG. 2 illustrates a block diagram of an indoor location system comprising a mobile device and a beacon, according to an embodiment;

FIG. 3 illustrates a schematic view showing different types of communication between a mobile device and a beacon, according to an embodiment;

FIG. 4 illustrates a schematic view of a configuration of an indoor positioning system in which a mobile device and a beacon exchange data using both an advertising mode and a connected mode of communication, according to an embodiment;

FIG. 5 illustrates a schematic view of a configuration of an indoor positioning system in which a mobile device and a beacon exchange data using both an advertising mode only, according to an embodiment;

FIG. 6 illustrates a schematic diagram depicting a communication process between a mobile device, a server, and a beacon, according to an embodiment;

FIG. 7 illustrates a schematic view of a communication process between a smartphone and a beacon, according to an embodiment;

FIG. 8 illustrates a flowchart for a process of determining the location of a mobile device, according to an embodiment;

FIG. 9 illustrates a flowchart for a beacon operation process in an ultra-wideband location system, according to an embodiment;

FIG. 10 illustrates a flowchart for a location determination process using GPS and ultrawideband beacons, according to an embodiment;

FIG. 11 illustrates a flowchart for an alternative location determination process using GPS and ultrawideband beacons, according to an embodiment; and

FIG. 12 illustrates a block diagram of an indoor positioning system with load balancing, according to an embodiment.

### DESCRIPTION OF EMBODIMENTS

The embodiments provide systems and methods that facilitate accurate indoor positioning using ultra-wideband (UWB) technology and mobile devices, such as smartphones. The systems and methods utilize a network of UWB beacons strategically placed within an indoor environment, along with specialized software on mobile devices, to enable precise location determination through UWB ranging and trilateration techniques. The embodiments leverage out-of-band communication channels, such as Bluetooth Low Energy or internet-based services, to efficiently exchange configuration data between UWB beacons and mobile devices, enabling rapid initiation of UWB ranging sessions and seamless transitions between outdoor GPS-based positioning and indoor UWB-based positioning.

The exemplary systems and methods utilize ultra-wideband (UWB) technology to achieve centimeter-level accuracy. This allows for significantly more precise indoor positioning compared to other methods which typically offer accuracy in the range of several meters.

The example embodiments described herein make use of ultra-wideband (UWB) technology. As used herein, “ultra-wideband” may include any radio technology that uses a very low energy level for short-range, high-bandwidth communications over a large portion of the radio spectrum. In some embodiments, devices operating using UWB radios may transmit over a band approximately between 3 and 10 Gigahertz (GHz). In some cases, devices operating using UWB radios may transmit over a band approximately between 6 and 9 GHz.

As used herein, “Bluetooth Low Energy” (BLE) may include a wireless personal area network technology designed and marketed by the Bluetooth Special Interest Group. BLE may operate in the 2.4 GHz ISM band and use a spread spectrum frequency hopping transceiver. BLE may be designed for short-range communication, typically with an operating range of up to approximately 10 meters. In some cases, BLE may have an extended range of up to 100 meters or more, depending on the specific implementation and environmental conditions. BLE may be optimized for low power consumption, making it suitable for use in small, battery-powered devices such as smartphones, wearables, and IoT devices. In other embodiments, other systems and protocols for enabling personal area network communication, including out-of-band communication, between mobile devices and beacons could be used, for example Zigbee, Z-Wave, and 6LoWPAN technologies.

The example embodiments described herein make use of beacons. As used herein, “beacon” (also referred to as an “anchor”) may include any fixed electronic device capable of wireless communication with mobile devices for the purpose of determining location. An ultrawideband beacon may be a beacon that is equipped with ultra-wideband. As discussed below, an ultrawideband beacon may also be equipped with other networking components, such as BLE, Wi-Fi, and/or Ethernet.

The example embodiments described herein make use of out-of-band channels. As used herein, “out-of-band communication” may include any communication method or medium separate from the primary communication mode/channel for data transmission. As examples, in the context of using UWB signals for making distance measurements between mobile devices and beacons, out-of-band communication may include Bluetooth Low Energy communication, HTTP/REST messages sent over a public network, or separate frequency bands used for control signaling.

The example embodiments described herein make use of the term payload. As used herein, “payload” may include any set of data transmitted as part of a communication between devices. As examples, payloads may include configuration data necessary for ultra-wideband ranging, device identifiers, or parameters required to initiate a communication session.

As used herein, “mobile device” may include any portable electronic device capable of wireless communication and data processing. Mobile devices may include smartphones, smart watches, tablets, or other mobile computing devices. These devices may be equipped with various sensors, networking capabilities, and processing power to support location-based services and applications. In some cases, mobile devices may incorporate ultra-wideband (UWB) technology for precise indoor positioning. Mobile devices may also utilize other positioning technologies such as GPS, as well as other networking components for communication, such as Wi-Fi, and Bluetooth low energy (BLE).

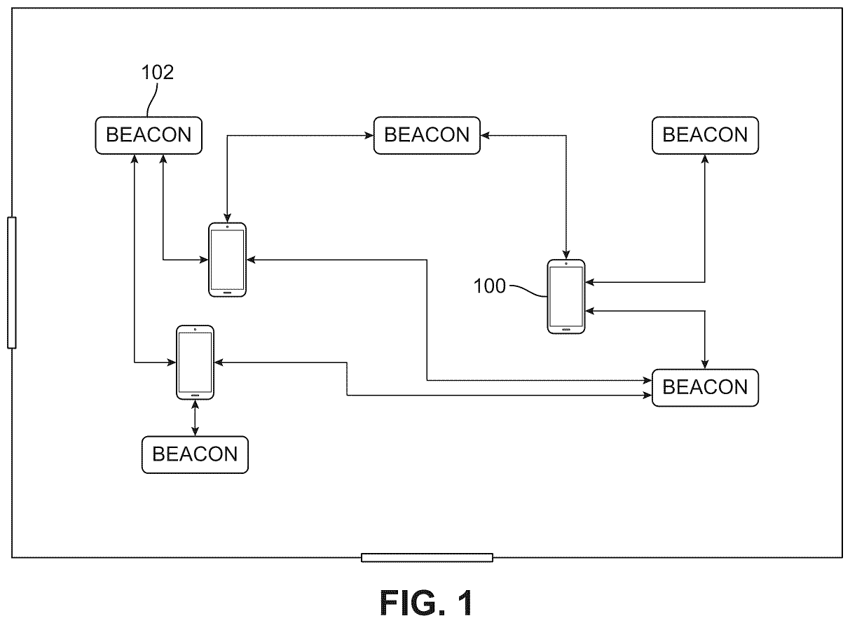

FIG. 1 illustrates a schematic view of various components associated with an indoor positioning system, which may be positioned within a room. The system may comprise multiple beacons (including beacon 102) and mobile devices (including mobile device 100). As discussed, communication may include UWB signaling (primary communication) and communication over BLE or REST APIs (secondary, or out-of-band communication).

In this example, the beacons (such as beacon 102) may have fixed positions inside a room (shown schematically), while the positions of the mobile devices (such as mobile device 100) may change. The embodiments leverage UWB systems on devices and beacons that can perform two-way UWB ranging to determine a distance between the devices that may be accurate to within a few centimeters. To determine a three-dimensional (3D) position for a mobile device, the mobile device may perform two-way ranging with at least three beacons to determine respective distances to each beacon. If the absolute 3D positions of the beacons are known, the three measured distances may be used to calculate a 3D position for the mobile device via the process of trilateration.

Two-way ranging with Ultra-Wideband (UWB) technology is a method used for precise distance measurement between two devices. In the exemplary UWB-based indoor positioning system, this technique may be employed to determine the distance between mobile devices, whose positions may change, and beacons, whose positions are fixed.

The process of two-way ranging typically involves several steps. A mobile device may initiate the ranging process by sending a poll message to a beacon. Upon receiving the poll message, the beacon may respond with a response message. The mobile device may then send a final message to complete the exchange. Both devices may record the timestamps of when messages are sent and received. These timestamps may be used to calculate the round-trip time of the signals. Using the round-trip time and accounting for processing delays, the system may calculate the distance between the two devices.

Two-way ranging with UWB may offer several advantages for indoor positioning. UWB signals may provide centimeter-level accuracy in distance measurements, allowing for highly precise location determination. The wide bandwidth of UWB signals may help mitigate multipath effects common in indoor environments, improving reliability in complex spaces. UWB technology may allow for efficient power usage, which may be beneficial for battery-powered mobile devices, potentially extending operational time between charges. Additionally, the ranging process may be completed quickly, allowing for real-time position updates, which may be crucial for applications requiring immediate location information.

In some implementations, the system may use a technique called Time of Flight (ToF) or Time of Arrival (ToA) to calculate distances. This method may rely on the precise timing capabilities of UWB technology to measure the travel time of signals between devices.

By performing two-way ranging with multiple beacons, a mobile device may obtain multiple distance measurements. These measurements may then be used in trilateration algorithms to determine the device's position within the indoor space.

As shown in FIG. 1, each mobile device may connect to multiple beacons and each beacon may connect to multiple mobile devices. This facilitates multiplexing, which allows each mobile device to engage in near simultaneous UWB signaling sessions with multiple beacons, as well as allowing each beacon to engage in near simultaneous UWB signaling sessions with multiple mobile devices. This multiplexing configuration may be contrasted with some architectures that effectively prevent one-to-many UWB sessions between beacons and mobile devices, respectively, due in part to inefficiencies in exchanging configuration data between devices prior to the transmission of UWB signals between devices.

In some cases, configuration data needed to facilitate UWB ranging may be exchanged between mobile devices and beacons by utilizing out-of-band messaging. This approach may offer reduced latency compared with other connection methods and facilitate near simultaneous two-way ranging sessions between multiple mobile devices and multiple beacons simultaneously.

In the context of setting up beacons in the exemplary room shown in FIG. 1, several steps may be taken to ensure optimal performance of the indoor positioning system. The process may begin with a detailed survey of the room to gather information about its physical characteristics, including dimensions, locations of doors, windows, and significant obstacles. This survey may also consider areas where users are likely to congregate and move through the space. Based on the survey, areas requiring precise location tracking may be identified, such as high-traffic zones or areas designated for specific location-based services.

The survey may also include an assessment of the existing infrastructure, identifying suitable locations for installing power sources and network connections for the beacons. Using specialized software, the optimal number and positions of beacons may be calculated, taking into account the room's layout, desired coverage areas, and the technical specifications of the UWB chips in both the beacons and smartphones. Once the optimal locations are determined, the beacons may be physically installed, mounted on walls or ceilings, ensuring they are securely fastened and properly oriented.

Each beacon may then be connected to its power source and, if required, to the network infrastructure. This may involve running cables or setting up wireless connections, depending on the beacon's specifications and the available infrastructure. Following installation, each beacon may be configured with its unique identifier and necessary network settings, including communication parameters for both UWB and out-of-band channels like Bluetooth Low Energy.

After installation and configuration, the system may be tested to ensure proper functionality, using test devices to verify accurate positioning throughout the desired coverage area. Based on these test results, minor adjustments to beacon positions or configurations may be made to optimize performance and coverage. A final round of testing may be conducted to confirm that the system meets the required specifications for accuracy, reliability, and coverage. By following this process, the indoor positioning system depicted in FIG. 1 may be set up to provide accurate location services for smartphone (or other mobile device) users within the room.

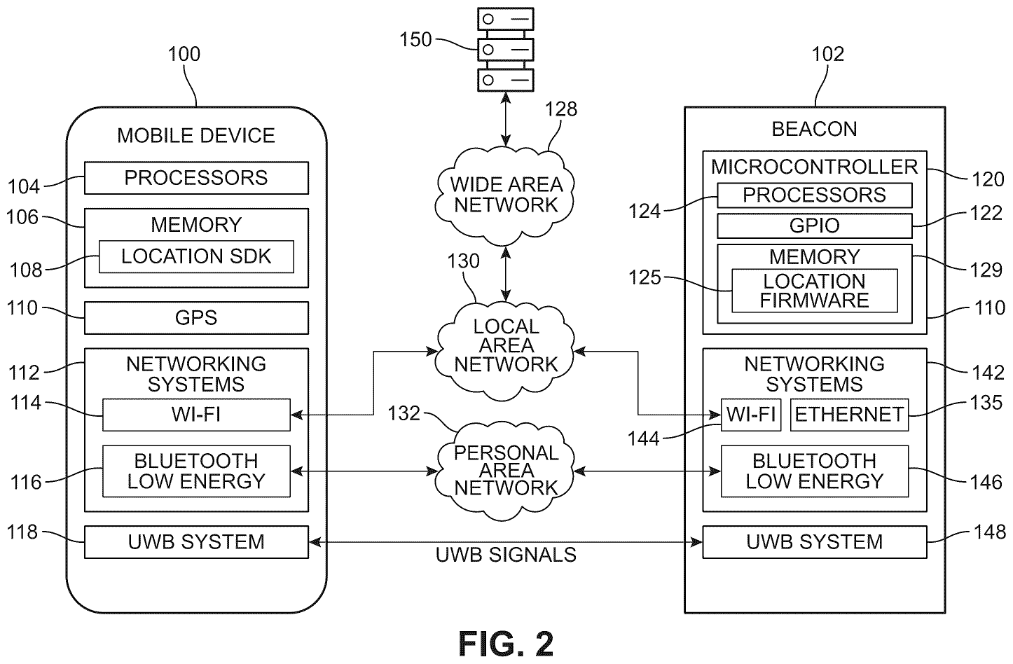

FIG. 2 illustrates a block diagram of an indoor location system comprising a mobile device and a beacon. The system may include components and connections that enable precise indoor positioning using ultra-wideband (UWB) technology.

In some embodiments, the mobile device 100 may include processors 104 and memory 106 for storing instructions executable by the processors 104. The mobile device 100 may also include a GPS 110 module, and networking systems 112. The networking systems 112 may facilitate the low latency exchange of configuration data (payloads) ahead of UWB two-way ranging sessions. In an exemplary embodiment, the networking systems 112 include Wi-Fi 114 and Bluetooth Low Energy (BLE) 116 components that enable communication over out-of-band channels. The mobile device 100 may also incorporate a UWB system 118 for ranging measurements.

In some cases, the Wi-Fi 114, BLE 116 and UWB system 118 may be provided as separate chips within the mobile device 100. This modular approach may allow for flexibility in device design and manufacturing, potentially enabling easier upgrades or replacements of individual components. In other implementations, these components may be integrated into a single chip or system-on-chip (SoC) solution, which may offer benefits such as reduced power consumption, smaller form factor, and potentially lower production costs. The specific configuration may vary depending on the mobile device manufacturer, target market, and technological advancements in chip design and integration.

The beacon 102 may include a microcontroller 120 with processors 124, General Purpose Input/Output (GPIO) 122, and memory 129 (including, RAM, ROM and other forms of storage). Beacon 102 may include networking systems 142 that facilitate low latency exchange of configuration data (payloads) ahead of UWB two-way ranging sessions. In the exemplary embodiment, the networking systems 142 include Wi-Fi 144 and Ethernet 135 components, as well as Bluetooth Low Energy 146 components. The beacon may also feature a UWB system 148 for ranging measurements.

In some implementations, the beacon may be equipped with wired Ethernet connectivity 135, which may include Power over Ethernet (PoE) capabilities. This feature may provide an efficient means for powering the beacon and establishing network connectivity simultaneously. By utilizing PoE, the need for separate power cables may be eliminated, potentially simplifying installation and reducing clutter in the deployment environment. This approach may be particularly beneficial in scenarios where access to traditional power outlets is limited or where a more streamlined infrastructure is desired. Additionally, the use of PoE may enhance the reliability and stability of the beacon's network connection, which may be crucial for maintaining accurate and consistent indoor positioning services.

The mobile device and the beacon may include software to facilitate communication and interaction of the various components and sub-systems that enable precise indoor location. The mobile device may include a location software development kit (SDK) that is stored in memory on the mobile device. In some cases, the location SDK may be included within mobile applications running on the mobile device, thereby enabling those mobile applications to use the indoor location services. The beacon may include software in the form of location firmware 125 stored in its memory.

In some cases, communication between the location SDK on the mobile device and the location firmware on the beacon may occur over out-of-band channels such as BLE or HTTP/REST. For example, in some cases, communication may occur over a personal area network (PAN) 132 using a Bluetooth low energy radio on each of the mobile device and the beacon. In some cases, communication may occur over a Local Area Network (LAN) 130, such as over Wi-Fi or Ethernet. In some cases, communication occurs over a Wide Area Network 128, such as the Internet. In some cases, communication with a remote server 150 occurs through a combination of LAN and WAN networks. In one embodiment, the mobile device and the beacon may both communicate using Wi-Fi or Ethernet to connect with remote servers. Communication may be facilitated using HTTP/REST or another suitable protocol to post and retrieve configuration/payload data. This system architecture may enable communication and data exchange between the mobile device and beacon through multiple channels.

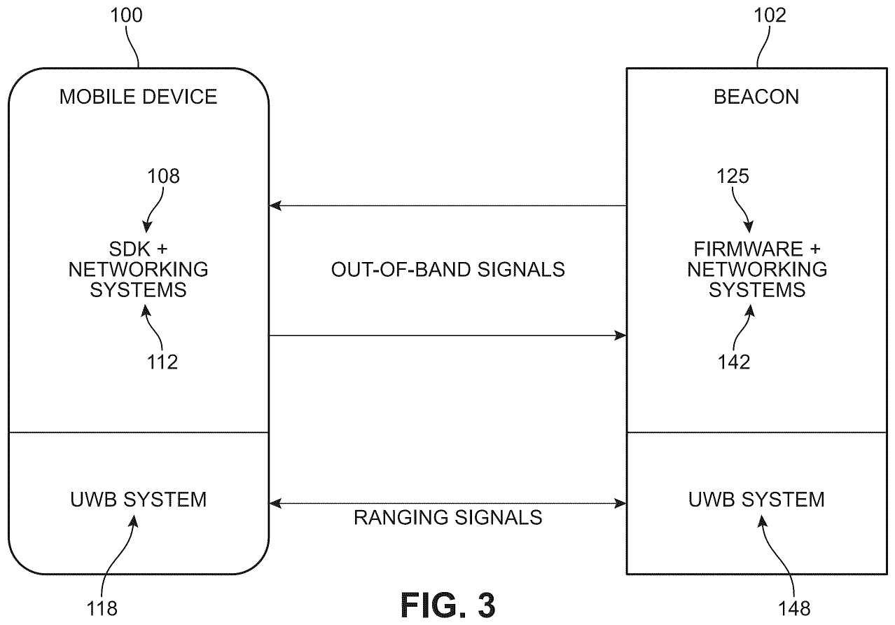

FIG. 3 illustrates a schematic view showing the different types of communication enabled by the architecture of FIG. 2. The diagram depicts two distinct communication channels between a mobile device and a beacon in the indoor positioning system.

In some aspects, the SDK 108 of mobile device 100 communicates with firmware 125 of beacon 102 via out-of-band signaling. Specifically, SDK 108 leverages networking systems 112 of the mobile device 100 to communicate, while firmware 125 uses networking systems 142 of the beacon 102 to communicate. This communication channel may be used for exchanging configuration and control data necessary for initiating and managing UWB ranging sessions.

Examples of configuration data that may be exchanged via out-of-band communication includes, but is not limited to: unique IDs for both the mobile device and the beacon to ensure proper pairing and data association (unique identifiers); specific frequency channels to be used for the UWB ranging session (UWB channel information); sequences used at the beginning of UWB transmissions for synchronization (preamble codes); parameters that define the rate at which UWB pulses are transmitted (Pulse Repetition Frequence values); transmission power levels; ranging session parameters (such as the number of ranging rounds to perform and the time interval between rounds); time stamp formats; antenna configurations; calibration data; encryption keys (for secure transmission); beacon position (3D fixed beacon coordinates); session identifiers, as well as other suitable information.

The second type of communication shown in FIG. 3 may be comprised of UWB ranging signals, which may be exchanged between the UWB systems within each of the mobile device 100 (in particular, UWB system 118) and the beacon 102 (in particular, UWB system 148) once the configuration data has been exchanged. The signaling that occurs in this channel may enable the precise distance measurement between the mobile device and the beacon.

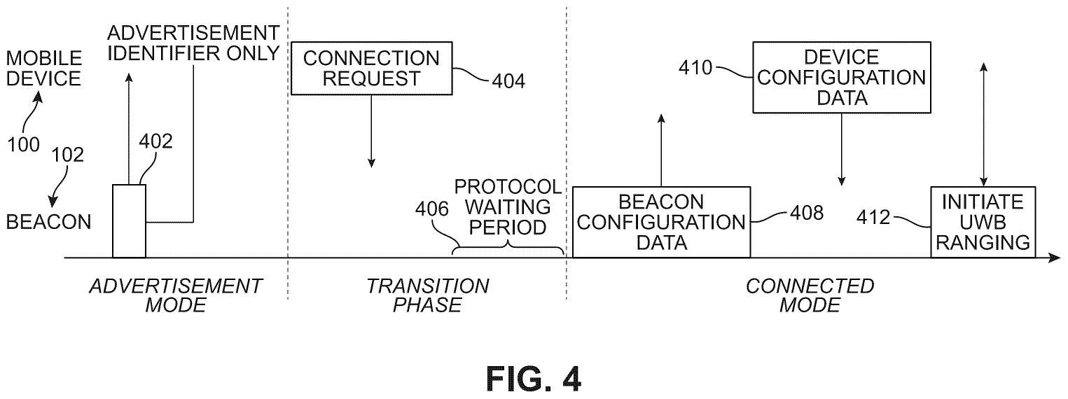

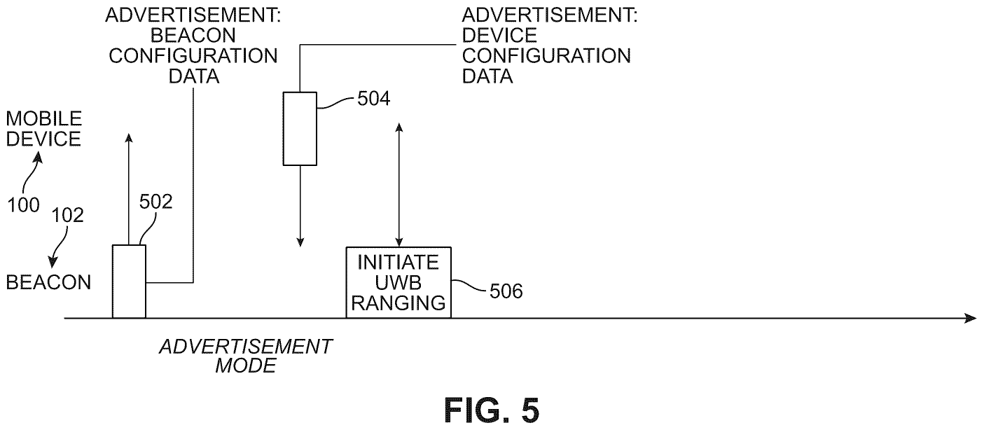

Some architectures may effectively limit or prevent one-to-many communication between each beacon and multiple mobile devices (such as smartphones), respectively. This may be due to inefficiencies in communicating configuration data that must be first exchanged between each mobile device and the beacon prior to initiating UWB ranging. To better understand how various communication configurations and architectures may effect the ability to perform multiplexing, two possible communication modes over BLE are shown in FIGS. 4 and 5. In FIG. 4, communication occurs using both an advertisement mode and a connected mode, whereas, in FIG. 5, communication occurs using an advertisement mode only.

Referring first to FIG. 4, information is exchanged using both an advertisement mode and a connected mode. Additionally, there is a period of time (denoted as the transition phase) between the advertisement mode and the connected mode that is dictated by the particular BLE communication protocol. This process may begin with the beacon in Advertisement Mode, sending out an advertisement 402 containing only its identifier. Upon receiving the information in the advertisement, the mobile device may then initiate a Connection Request 404. As shown, there may be a delay between the time the connection request is made and when the connected mode begins. This period of time (denoted as a protocol waiting period 406) may be part of the underlying communication protocol, such as the communication protocol use with Bluetooth low energy. After the delay, the process enters the connected mode. At this point the mobile device and the beacon have an open connection and may begin exchanging data, including beacon configuration data 408 and device configuration data 410 for UWB ranging. Finally, the beacon may initiate UWB ranging 412 between the mobile device and the beacon so that a distance measurement can be obtained.

FIG. 5 shows a streamlined process for initiating UWB ranging between the mobile device and the beacon by using only an advertising mode to exchange configuration data via BLE. As before, the process begins with the beacon in an advertisement mode. Specifically, the beacon advertises its configuration data. This includes any data sufficient for the mobile device to set up a two-way ranging session with the beacon. This data, also referred to as the ‘beacon payload’ (beacon payload 502), is broadcast using the advertisement channels of the associated Bluetooth low energy channel spectrum. The mobile device may retrieve this information and use it to set up a new UWB two-way ranging session. The mobile device may generate its own configuration data and then advertise this information (‘mobile device payload 504) over the same (or similar) advertisement channels used by the beacon. As soon as the beacon detects the mobile device payload on one or more of the advertising channels, the beacon retrieves this data and uses it to initiate the UWB two-way ranging session 506 with the mobile device. At this point, both devices begin sending transmitting (and receiving) UWB signals over their associated UWB systems so that a distance measurement between the devices can be made.

As seen by comparing the two processes of FIGS. 4 and 5, by using only the BLE advertising channels to communicate (that is, broadcast) configuration data from both the beacon and mobile device, data can be exchanged much more quickly compared to using the connected mode to exchange configuration data. In some cases, configuration data exchanged using advertising channels only may be ten to one hundred time faster than data exchanged using the connected mode. As an example, a UWB session initiated using the process of FIG. 4 might take several seconds, while data exchanged using the process of FIG. 5 (advertisement only) may take 100 to 200 milliseconds. Because precise indoor location may require continuously updating ranging measurements between multiple mobile devices and multiple beacons many times a second, communication modes taking more than a second are practically infeasible to achieving true multiplexing between beacons and mobile devices.

While FIGS. 4 and 5 show examples of exchanging configuration data over a personal area network such as BLE, in other embodiments out-of-band channeling may occur using other methods, such as a REST API.

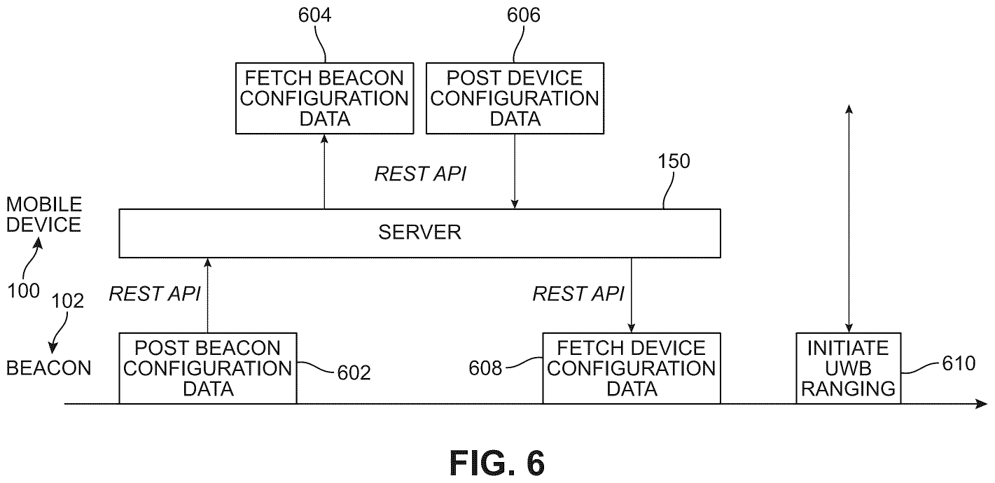

FIG. 6 illustrates a sequence diagram depicting the communication process between a mobile device, a server, and a beacon for configuring and initiating UWB (Ultra-Wideband) ranging using an out-of-band channel. In this embodiment, the server may act as an intermediary to facilitate the exchange of configuration data between the mobile device and beacon. In particular, communication between the beacon and the mobile device occurs over an out-of-band channel that comprises a REST API.

REST APIs may provide a standardized way for different software systems to communicate over the internet, making them well-suited for exchanging configuration data between mobile devices, beacons, and servers. REST APIs may be closely tied to the HTTP (Hypertext Transfer Protocol) protocol, which is the foundation of data communication on the World Wide Web. In the context of the indoor positioning system, HTTP may serve as the underlying protocol for transmitting REST API requests and responses between devices.

When using a REST API, devices may send HTTP requests to specific URLs (Uniform Resource Locators) that represent different resources or actions. These requests may use standard HTTP methods such as GET (to retrieve data), POST (to send data), PUT (to update data), or DELETE (to remove data). In response, the server may send back data, often in a format such as JSON (JavaScript Object Notation) or XML (eXtensible Markup Language). For example, in the system depicted in FIG. 6, the beacon may use a POST request to send its configuration data to the server. The mobile device may then use a GET request to retrieve this data from the server, which may be provided in JSON, XML or any other suitable format. This approach may allow for efficient and standardized communication between devices. Moreover, communication via the REST API may enable configuration data to be exchanged sufficiently quickly (in hundreds of milliseconds, for example) to enable multiplexing between mobile devices and beacons.

The process of FIG. 6 may begin with the beacon 102 posting its configuration data (activity 602) to the server 150 using a REST API. This step may ensure that the beacon's information is available for retrieval by other devices. Next, the mobile device 100 may fetch the beacon configuration data from the server 150 (activity 604), also using a REST API. This may allow the mobile device 100 to obtain necessary information about the beacon it will interact with.

After receiving the beacon data, the mobile device 100 may generate and post its own configuration data to the server (activity 606). This step may enable the beacon 102 to retrieve information about the mobile device 100. The beacon may then fetch the mobile device's configuration data from the server using the REST API (activity 608).

With both the mobile device 100 and beacon 102 having each other's configuration information, they may be prepared to initiate UWB ranging. The final step shows the beacon 102 initiating the UWB ranging process with the mobile device 100 (activity 610), utilizing the configuration data exchanged through the server to establish a direct UWB connection for precise distance measurement.

This approach may provide flexibility in scenarios where direct communication between the mobile device and beacon for configuration exchange is not feasible or efficient. It may also allow for centralized management of device configurations and potentially enable additional features such as logging and analytics. In some cases, as discussed below, the use of a remote server to facilitate out-of-band communication may also facilitate dynamically changing which devices and beacons are allowed to communicate, thereby facilitating a kind of load balancing in scenarios where there is a sufficient density of mobile devices in a room.

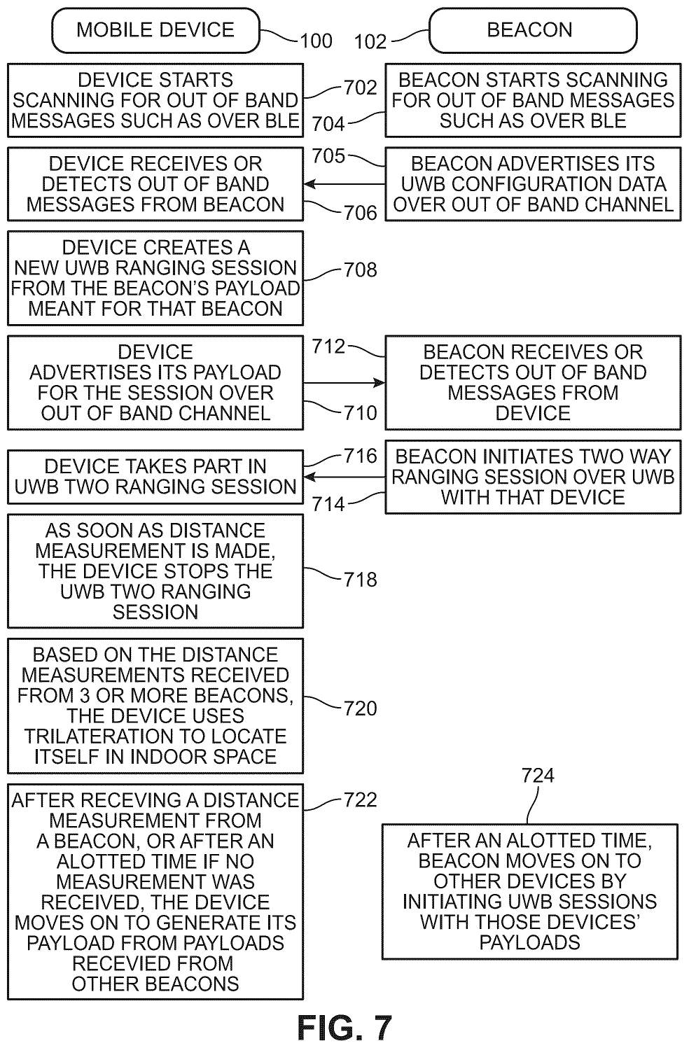

FIG. 7 illustrates a schematic view of the communication process between a mobile device and a beacon for ultra-wideband (UWB) ranging. Initially, the mobile device may begin scanning for out-of-band messages as in block 702. In some cases, the out-of-band messages may be messages transmitted over Bluetooth Low Energy (BLE), including advertising messages. In other cases, the out-of-band messages may be messages accessed over a network such as the Internet, using a REST API. Simultaneously, the beacon may start scanning for out-of-band messages in block 704. The beacon may then advertise its UWB configuration data over the out-of-band channel in block 705.

The mobile device may receive or detect this out-of-band message from the beacon in block 706. Upon receiving this data, the mobile device may create a new UWB ranging session based on the beacon's payload and generate a payload specifically meant for that beacon in step 708. The mobile device may then advertise its payload for the session over the out-of-band channel in step 710.

Next, the beacon receives or detects the out-of-band message from the mobile device in block 712. The beacon may then initiate a two-way ranging session over UWB with that specific mobile device in block 714. The mobile device may participate in this UWB two-way ranging session in block 716. As soon as a distance measurement is made, the mobile device may stop the UWB two-way ranging session in block 718. Based on the distance measurements received from three or more beacons, the mobile device may use trilateration to locate itself in the indoor space in block 720.

After receiving a distance measurement from a beacon or after an allotted time if no measurement was received, the mobile device may move on to perform two-way ranging with other beacons in the room or area in block 722. Concurrently, after an allotted time, the beacon may move on to other mobile devices by initiating UWB sessions using those mobile devices' payloads in block 724. This looping process may ensure continuous updating of location data and allow the system to handle multiple mobile devices simultaneously.

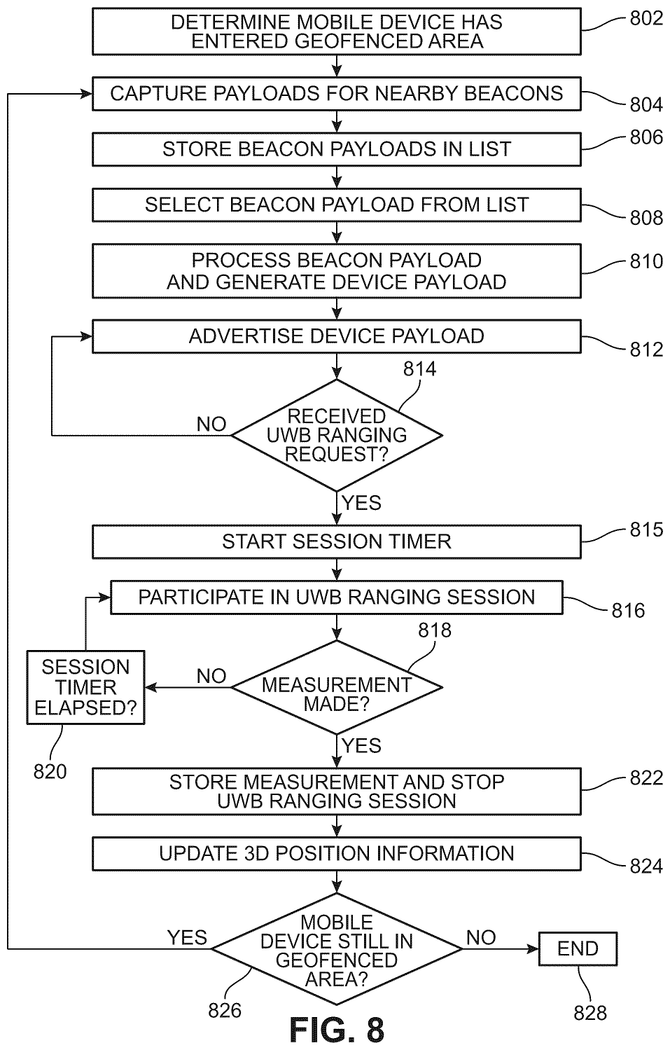

To facilitate multiplexing between mobile devices and beacons, the exemplary systems may include provisions for identifying and queueing devices for UWB ranging. FIG. 8 is a schematic view showing a process for a mobile device that includes identifying that the mobile device has entered an area with indoor locating infrastructure and continuously monitoring and queuing beacon payload data for further processing in order to facilitate UWB ranging with multiple beacons over a relatively short time frame. One or more operational blocks of the process may be performed by various components of the device, for example, by a processor based on instructions associated with the location SDK.

The process of FIG. 8 may begin at block 802 by determining if the mobile device has entered a geofenced area. Once confirmed, at block 804 the device may capture payloads for nearby beacons and store them in a list in block 806. The process may then proceed to block 808 to select a beacon payload from the list and process it to generate a device payload in block 810.

At block 812, the device payload may be advertised, and at block 814 the device may check to see if a UWB ranging request has been received. If no request is received, the device may continue to advertise the payload. If a ranging request has been received, the device may start a session timer in block 815 and then participate in a UWB ranging session with a beacon that has recently received the device's payload in block 816. At block 818 the device may check if a (distance) measurement has been made. At decision block 818, if a measurement has been made, the device continues to block 822. If not, at decision block 820 the device may check if the session timer has elapsed. The process may continue until either a measurement is made or the timer elapses.

Once a measurement is made, at block 822 the device may store the measurement and stop the UWB ranging session. Next, at block 824 the 3D position may be updated using the recent measurement and two or more other recent measurements from other nearby beacons. After this, at block 826 the process checks if the mobile device is still in the geofenced area. If so, the process may return to block 804 to select a new beacon payload from the list/queue of beacon payloads and repeat the process of trying to perform a two-way ranging session between the mobile device and the new beacon. If the mobile device is determined to no longer be in the geofenced area, the process may proceed to block 828 to END. At this point the mobile device stops searching for nearby beacons. Instead, the location of the mobile device is determine using other methods, such as GPS.

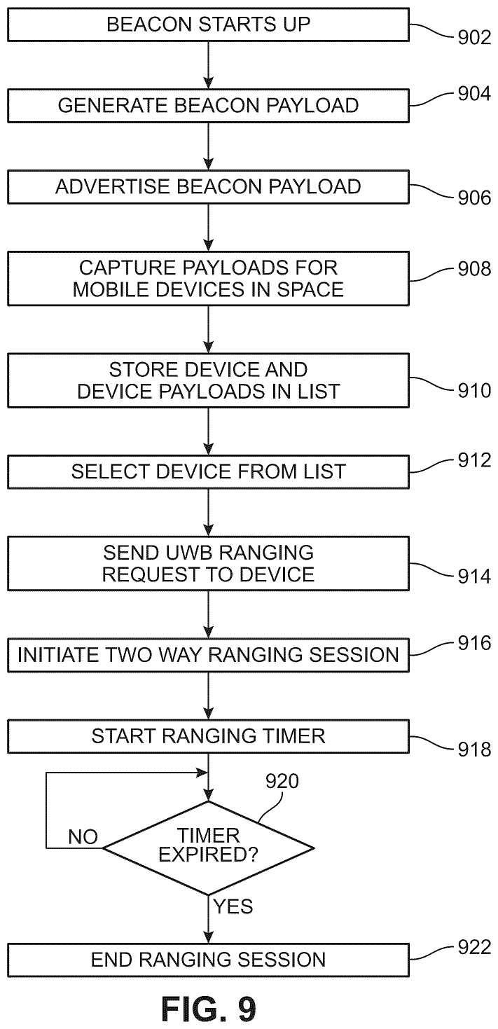

FIG. 9 illustrates a schematic view of a process that may be performed by a beacon to facilitate multiplexing between the beacon and multiple different mobile devices equipped with UWB systems. One or more of the steps or operational blocks may be performed by components of the beacon, such as by a processor based on instructions associated with the location firmware.

The process may begin when the beacon starts up in block 902. Following startup, the beacon may generate a beacon payload in block 904, which may contain information necessary for UWB ranging. The beacon may then advertise this payload in block 906, making it available to nearby devices.

The process may continue with the beacon capturing payloads from mobile devices in the nearby space in block 908. These captured payloads and associated device information may be stored in a list in block 910. The beacon may then select a mobile device from this list to initiate a ranging session in block 912.

Once a device is selected, the beacon may send a UWB ranging request to the chosen device in block 914. This request, once received at the mobile device, may initiate a two-way ranging session between the beacon and the mobile device in block 916. Immediately after initiating the session, the beacon may start a ranging timer in block 918.

The process may then enter a loop where it continuously checks if the timer has expired in block 920. If the timer has not expired, the process may continue to wait. When the timer expires, the ranging session with the current mobile device may end in block 922.

After ending the ranging session, the process may loop back to capture payloads for mobile devices in the space, allowing the beacon to interact with multiple devices in a sequential manner. This cycle may continue, enabling the beacon to perform ranging sessions with various devices in its vicinity over time.

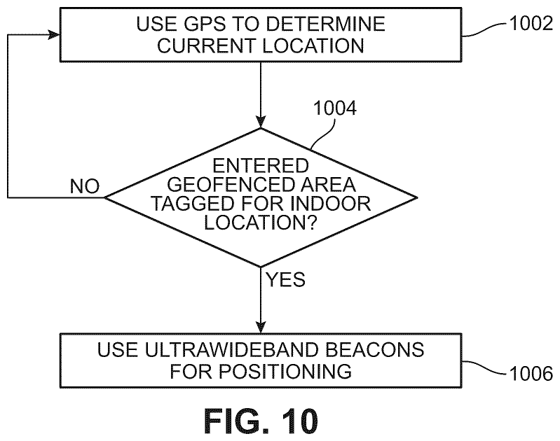

FIG. 10 illustrates a flowchart for a location determination process that may enable seamless transitioning between GPS-based positioning and ultrawideband beacon-based positioning. The process may begin with using GPS to determine the current location of a mobile device in block 1002. Following this initial location determination, the process may check if the mobile device has entered a geofenced area that may be tagged for indoor location services in block 1004. In particular, the process checks to see if the GPS location overlaps with a geofenced area associated with indoor locating services.

In some aspects, these geofenced areas may be predefined zones that are known to have ultrawideband beacon infrastructure installed. These areas may include indoor spaces such as shopping malls, airports, office buildings, casinos, hotels, or other locations where GPS signals may be weak or unreliable. The system may maintain a database of such geofenced areas, allowing for quick identification when a mobile device enters one of these zones.

If the condition of entering a geofenced area is met, the process may proceed to use ultrawideband beacons for positioning in block 1006. This transition may occur automatically, without requiring user intervention. The switch to ultrawideband-based positioning may allow for more precise location tracking in indoor environments where GPS signals may be unreliable or unavailable. Otherwise, in block 1004, as long as the mobile device remains out of a geofenced area, the device may continue to use GPS to determine its location as in block 1002.

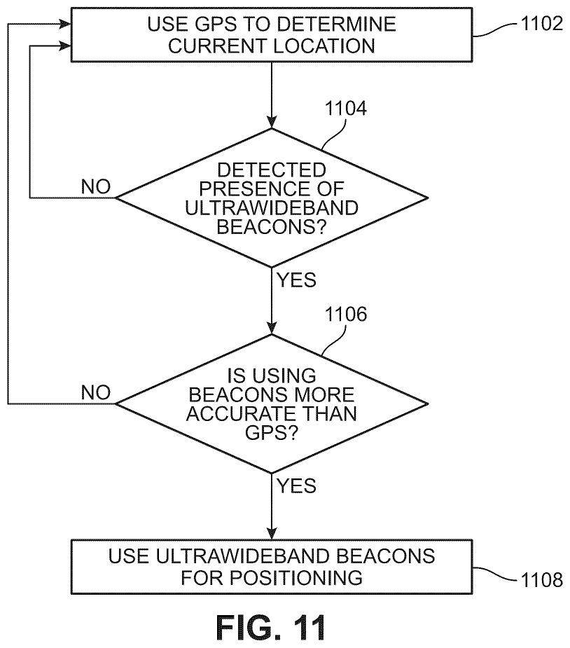

FIG. 11 illustrates another flowchart for a location determination process that may provide a more dynamic approach to transitioning between GPS-based positioning and ultrawideband beacon-based positioning. The process may begin with using GPS to determine the current location of a mobile device in block 1102. Following this initial location determination, the system may detect the presence of ultrawideband beacons in the vicinity in block 1104.

In some aspects, the detection of ultrawideband beacons may involve receiving Bluetooth Low Energy (BLE) signals from the beacons. These BLE signals may serve as an initial indicator of the presence of ultrawideband infrastructure in the area. The mobile device may scan for these signals periodically or continuously, depending on factors such as battery life considerations and movement patterns.

Once ultrawideband beacons are detected, the system may then determine if using the beacons and UWB ranging would result in a more accurate location than continuing to use GPS in block 1106. This determination may involve considering various factors such as the strength and number of GPS signals currently available, the number and signal strength of detected beacons, and other suitable factors.

The decision to switch from GPS to ultrawideband-based positioning may be based on a comparison of the estimated accuracy of each method. If the system determines that ultrawideband ranging with the detected beacons would provide a more accurate location, it may initiate the transition to beacon-based positioning in block 1108. By dynamically evaluating the potential accuracy of GPS versus ultrawideband positioning, the system may optimize location accuracy across a wide range of environments, including areas where GPS performance may be degraded but not entirely unavailable.

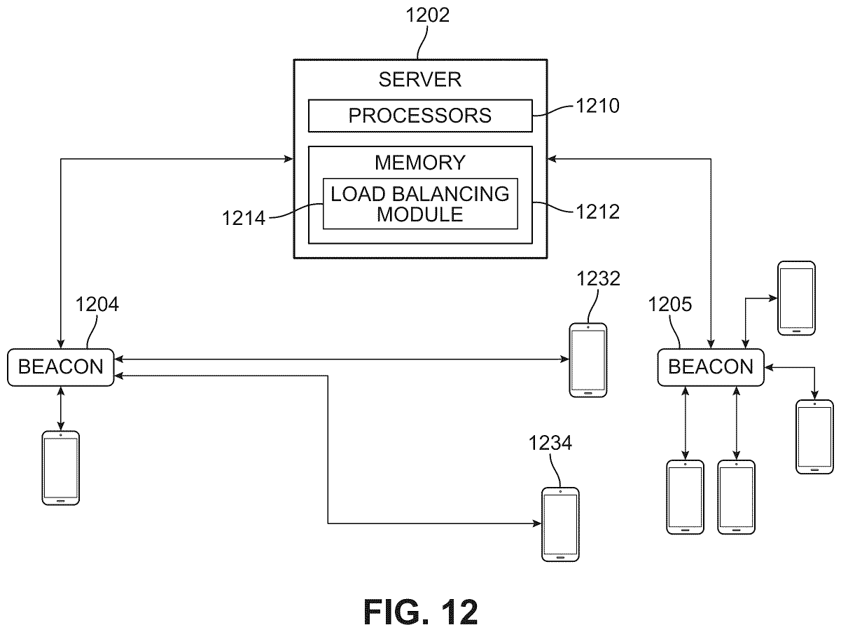

FIG. 12 illustrates a block diagram of an indoor positioning system that may include provisions for managing connections between multiple beacons and mobile devices. The system may comprise a server 1202, multiple beacons (for example, beacon 1204 and beacon 1205), and several mobile devices (including mobile device 1232 and mobile device 1234). In some aspects, the server 1202 may include processors 1210, memory 1212, and a load balancing module 1214, or routing module, stored in the memory. The beacons may be distributed throughout the environment and may communicate with both the server and the mobile devices. The mobile devices may interact with the beacons and, in some cases, directly with the server.

The system may include a load balancing module 1214 that may be used to determine which mobile devices should connect to which beacons. For example, some beacons may be capable of communicating with a limited number of devices. In one example, each beacon may only communicate with ten mobile devices simultaneously. The load balancing module may analyze all mobile devices and beacons in a room or general area and determine which mobile devices should connect to which beacons (and vice versa). That is, the load balancing module (or routing module) routes mobile devices to selected beacons to optimize operation of the system. In the example of FIG. 12, some devices (for example, device 1232 and device 1234) might be closer to one beacon (beacon 1205), but are instructed to connect to a beacon further away (beacon 1204) to limit overloading the closer beacon, which is also connected to four more mobile devices. The load balancing module may also help ensure mobile devices connect with beacons that are optimally placed for determining the mobile device's location.

By incorporating a load balancing mechanism, the system may efficiently manage resources and optimize the distribution of connections between beacons and mobile devices. This approach may help maintain system performance and accuracy, especially in environments with high device density or varying beacon capabilities.

In some embodiments, the load balancing module may be used to dynamically turn beacons on and off according to the number of devices and their relative locations within a space. This functionality may allow the system to adapt to changing conditions in real-time, potentially optimizing power consumption and network resources. For example, in areas with low device density, the system may turn off some beacons to conserve energy. Conversely, in high-traffic areas or during peak usage times, additional beacons may be activated to handle increased demand. The dynamic activation and deactivation of beacons may also help in managing signal interference and improving overall system performance. By adjusting the active beacon network based on current needs, the system may maintain optimal coverage and accuracy while potentially reducing operational costs and extending the lifespan of the beacon infrastructure.

For each of the exemplary processes described above including multiple steps, it may be understood that in other embodiments some steps may be omitted and/or reordered. In some other embodiments, additional steps could also be possible.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

1. A mobile device, comprising:
an ultrawideband component for sending and receiving ultrawideband signals;
a networking component;
the mobile device configured to:
retrieve, using the networking component, beacon data from one or more advertising communication channels, the beacon data associated to an ultrawideband beacon;
generate mobile device data for the ultrawideband beacon, the mobile device data corresponding to an ultrawideband two-way ranging session;
advertise, using the networking component, the mobile device data over the one or more advertising communication channels;
use the ultrawideband component to perform two-way ranging with the ultrawideband beacon and obtain a distance measurement; and
calculate a position for the mobile device using the distance measurement.

2. The mobile device according to claim 1, wherein the networking component includes a Bluetooth low energy device.

3. The mobile device according to claim 1, wherein the mobile device is further configured to:
retrieve beacon data from multiple ultrawideband beacons;
perform two-way ranging with the multiple ultrawideband beacons; and
calculate the position for the mobile device using distance measurements from the multiple ultrawideband beacons.

4. The mobile device according to claim 1, wherein the mobile device is further configured to:
determine if the mobile device has entered a geofenced area associated with indoor location services before retrieving the beacon data.

5. The mobile device according to claim 1, wherein the mobile device is further configured to:
detect nearby ultrawideband beacons; and
determine whether to use ultrawideband-based positioning or GPS-based positioning.

6. The mobile device according to claim 1, wherein the mobile device is further configured to:
store the beacon data in a list, the list including additional beacon data from additional nearby beacons; and
generate mobile device data for multiple ultrawideband beacons in a sequential manner.

7. A mobile device, comprising:
an ultrawideband component for sending and receiving ultrawideband signals;
a networking component;
the mobile device configured to:
retrieve, using the networking component, beacon data from a server, the beacon data associated to an ultrawideband beacon;
generate mobile device data for the ultrawideband beacon, the mobile device data corresponding to an ultrawideband two-way ranging session;
send the mobile device data, using the networking component, to the server;
use the ultrawideband component to perform two-way ranging with the ultrawideband beacon and obtain a distance measurement; and
calculate a position for the mobile device using the distance measurement.

8. The mobile device according to claim 7, wherein the networking component includes a Wi-Fi device.

9. The mobile device according to claim 7, wherein the mobile device is further configured to:
retrieve beacon data from multiple ultrawideband beacons;
perform two-way ranging with the multiple ultrawideband beacons; and
calculate the position for the mobile device using distance measurements from the multiple ultrawideband beacons.

10. The mobile device according to claim 7, wherein the mobile device is further configured to:
determine if the mobile device has entered a geofenced area associated with indoor location services before retrieving the beacon data from the server.

11. The mobile device according to claim 7, wherein the mobile device is further configured to:
detect nearby ultrawideband beacons; and
determine whether to use ultrawideband-based positioning or GPS-based positioning.

12. The mobile device according to claim 7, wherein the mobile device is further configured to:
store the beacon data in a list, the list including additional beacon data from additional nearby beacons; and
generate mobile device data for multiple ultrawideband beacons in a sequential manner.

13. The mobile device according to claim 7, wherein the mobile device is further configured to:
post the mobile device data to the server using a REST API; and
retrieve the beacon data from the server using the REST API.

14. An ultrawideband beacon, comprising:
an ultrawideband component for sending and receiving ultrawideband signals;
a networking component;
the beacon configured to:
create beacon data including information for mobile devices trying to engage in ultrawideband ranging with the beacon;
advertise, using the networking component, the beacon data over an advertising communication channel;
retrieve, using the networking component, mobile device data generated by a mobile device over the advertising communication channel, the mobile device data corresponding to an ultrawideband two-way ranging session; and
use the ultrawideband component to perform two-way ranging with the mobile device and obtain a distance measurement.

15. The ultrawideband beacon according to claim 14, wherein the networking component includes a Bluetooth low energy device.

16. The ultrawideband beacon according to claim 14, wherein the beacon is further configured to:
store the mobile device data in a list, the list including additional mobile device data from additional mobile devices; and
perform two-way ranging with multiple mobile devices in a sequential manner.

17. The ultrawideband beacon according to claim 14, wherein the beacon is further configured to:
initiate a ranging timer after beginning two-way ranging with the mobile device; and
end the two-way ranging session when the ranging timer expires.

18. The ultrawideband beacon according to claim 14, wherein the beacon is further configured to:
communicate with a server to receive load balancing instructions; and
selectively engage in two-way ranging with mobile devices based on the load balancing instructions.

19. The ultrawideband beacon according to claim 14, wherein the beacon data includes information beacon location information.

20. The ultrawideband beacon according to claim 14, wherein the beacon is further configured to:
post the beacon data to a server using a REST API; and
retrieve the mobile device data from the server using the REST API.
